(19) United States
(12) Patent Application Publication
(10) Pub. No.: US 2020/0383523 A1
(43) Pub. Date: Dec. 10, 2020

(54) CHICKEN ROASTING OVEN CAPABLE OF CONDUCTING MULTIDIMENSIONAL ROASTING

(71) Applicant: Ningbo Jinyu Electric Appliance Co., Ltd., Yuyao City (CN)

(72) Inventors: Junda Shi, Yuyao City (CN); Zhongyu Shi, Yuyao City (CN); Shukuo Liu, Yuyao City (CN); Yinlu Wang, Yuyao City (CN)

(21) Appl. No.: 16/528,759

(22) Filed: Aug. 1, 2019

(30) Foreign Application Priority Data
Jun. 5, 2019 (CN) 201920839133.6

(51) Int. Cl. A47J 37/06; H05B 3/00; H05B 3/26

(52) U.S. Cl. CPC A47J 37/0629; H05B 3/26; H05B 3/0076

(57) ABSTRACT

The present invention discloses a chicken roasting oven capable of conducting multidimensional roasting, which includes a housing, a lid, an inner and outer pot. The inner pot is fixedly arranged in the housing, the outer pot is placed in the inner pot, strip-shaped heating elements are arranged on the inner side wall of the inner pot and connected end to end, a sheet-shaped heating element is arranged at the bottom of the inner pot, the lid can cover the top end of the housing, a thermal insulation plate and a liner are sequentially and fixedly arranged at the bottom end of the lid, a light wave tube is fixedly arranged at the bottom end of the liner and covered by a screen, and the sheet-shaped and strip-shaped heating elements and light wave tube are respectively electrically connected with a multistage switch and a power supply.

### CROSS-REFERENCE TO RELATED APPLICATION

This application claims benefit of Chinese Application number 201920839133.6 filed Jun. 5, 2019, entitled “CHICKEN ROASTING OVEN CAPABLE OF CONDUCTING MULTIDIMENSIONAL ROASTING.”

### TECHNICAL FIELD

The present invention relates to the technical field of ovens, and in particular, to a chicken roasting oven capable of conducting multidimensional roasting.

### BACKGROUND

A chicken roasting oven is a special machine for roasting a chicken. The existing chicken roasting oven generally includes an oven body with an internal thermal insulation layer, an electric heating device arranged at the lower portion of the interior of the oven body, a transverse rack arranged at the upper portion of the oven body and a grill hung on the transverse rack. A common chicken roasting oven only has one electric heating device so as to have a too long chicken roasting time and consume too much fuel, and actually the chicken is cooked in a braising manner; furthermore, its thermal radiation is nonuniform so as to cause that roasting cannot be uniform in use and a roasted chicken is partially cooked or burned.

### SUMMARY

An objective of the present invention is to provide a chicken roasting oven capable of conducting multidimensional roasting in order to solve the problems in the prior art and help thermal radiation in the chicken roasting oven to be uniform so as to improve the roasting quality.

To achieve the above objective, the present invention provides the following technical solutions: A chicken roasting oven capable of conducting multidimensional roasting includes a housing, a lid, an inner pot and an outer pot, wherein the inner pot is fixedly arranged in the housing, the outer pot is placed in the inner pot, strip-shaped heating elements are arranged on the inner side wall of the inner pot and are connected end to end, a sheet-shaped heating element is arranged at the bottom of the inner pot, the lid can tightly cover the top end of the housing, a thermal insulation plate and a liner are sequentially and fixedly arranged at the bottom end of the lid from top to bottom, a light wave tube is fixedly arranged at the bottom end of the liner, a screen covers the light wave tube, and the sheet-shaped heating element, the strip-shaped heating elements and the light wave tube are respectively electrically connected with a multistage switch and a power supply.

Preferably, the housing comprises an outer housing and a bottom cover, the bottom cover is fixedly connected with the inner pot through screws, and the outer housing is tightly clamped between the bottom cover and the inner pot.

Preferably, at least three feet are fixedly arranged at the bottom end of the bottom cover, and at least two handles are arranged on the outer side wall of the outer housing.

Preferably, a support is fixedly arranged at the bottom end of the liner, the light wave tube is fixedly arranged on the support, and the light wave tube just faces to the outer pot.

Preferably, a rack is arranged in the outer pot, and the rack and the outer pot are detachably connected.

Preferably, the outer pot and the inner pot are detachably connected.

Preferably, a lifting handle is arranged at the top end of the top cover.

Preferably, the lid is further provided with an upper connector assembly.

In comparison with the prior art, the chicken roasting oven capable of conducting multidimensional roasting of the present invention has the following technical effects:

the chicken roasting oven capable of conducting multidimensional roasting of the present invention can roast a chicken under multidimensional radiation, has uniform thermal radiation and improves the roasting quality. An outer pot and a rack in the chicken roasting oven capable of conducting multidimensional roasting of the present invention are detachable, can be cleaned singly and are convenient to use. The chicken roasting oven capable of conducting multidimensional roasting of the present invention has three heating components, namely, strip-shaped heating elements, a sheet-shaped heating element and a light wave tube, can conduct three-dimensional radiation roasting on the chicken, can have various heating modes by combining the three heating components, and can be suitable for various conditions of roasting the chicken, thawing before roasting, thermally insulating after roasting and the like.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic structural diagram of a chicken roasting oven capable of conducting multidimensional roasting of the present invention; and

FIG. 2 is an exploded view of the chicken roasting oven capable of conducting multidimensional roasting of the present invention.

In the drawings: 1—lifting handle, 2—lid, 3—thermal insulation plate, 4—liner, 5—outer pot, 6—outer housing, 7—handle, 8—rack, 9—bottom cover, 10—feet, 11—upper connector assembly, 12—support, 13—light wave tube, 14—screen, 15—strip-shaped heating element, 16—inner pot, and 17—sheet-shaped heating element.

### DETAILED DESCRIPTION OF EMBODIMENTS

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

An objective of the present invention is to provide a chicken roasting oven capable of conducting multidimensional roasting in order to solve the problems in the prior art and ensure that thermal radiation in the chicken roasting oven is uniform so as to improve the roasting quality.

The chicken roasting oven capable of conducting multidimensional roasting provided by the present invention includes a housing, a lid, an inner pot and an outer pot, the inner pot is fixedly arranged in the housing, the outer pot is placed in the inner pot, strip-shaped heating elements are arranged on the inner side wall of the inner pot and are connected end to end, a sheet-shaped heating element is arranged at the bottom of the inner pot, the lid can tightly cover the top end of the housing, a thermal insulation plate and a liner are sequentially and fixedly arranged at the bottom end of the lid from top to bottom, a light wave tube is fixedly arranged at the bottom end of the liner, a screen covers the light wave tube, and the sheet-shaped heating element, the strip-shaped heating elements and the light wave tube are respectively electrically connected with a multistage switch and a power supply.

The chicken roasting oven capable of conducting multidimensional roasting of the present invention can roast a chicken under multidimensional radiation, has uniform thermal radiation and improves the roasting quality.

To make the foregoing objective, features, and advantages of the present invention clearer and more comprehensible, the present invention is further described in detail below with reference to the accompanying drawings and specific embodiments.

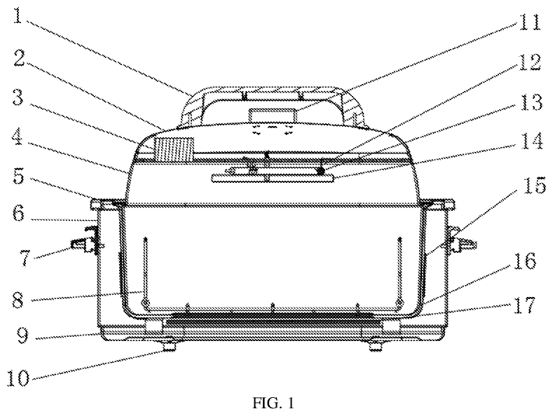

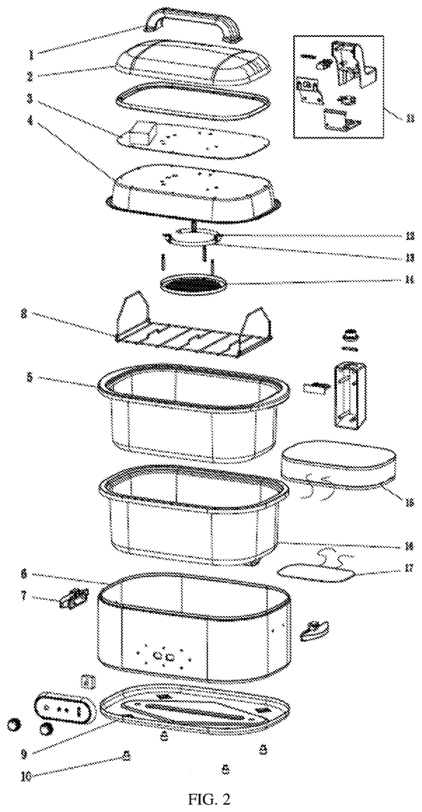

As shown in FIG. 1 and FIG. 2, the chicken roasting oven capable of conducting multidimensional roasting in embodiment includes a housing, a lid 2, an inner pot 16 and an outer pot 5, the housing includes an outer housing 6 and a bottom cover 9, four foot 10 are fixedly arranged at the bottom end of the bottom cover 9, and two handles 7 are arranged on the outer side wall of the outer housing 6.

The inner pot 16 is fixedly arranged in the housing, the inner pot 16 is fixedly connected with the bottom cover 9 through screws, and the outer housing 6 is tightly clamped between the bottom cover 9 and the inner pot 16. The outer pot 5 is placed in the inner pot 16, the outer pot 5 and the inner pot 16 are detachably connected, strip-shaped heating elements 15 are arranged on the inner side wall of the inner pot 16, the strip-shaped heating elements 15 are connected end to end to form a circle, a sheet-shaped heating element 17 is arranged at the bottom of the inner pot 16, the lid 2 can cover the top end of the housing tightly, a thermal insulation plate 3 and a liner 4 are sequentially and fixedly arranged at the bottom end of the lid 2 from top to bottom, and the thermal insulation plate 3 can lock internal heat of the pot in an internal space defined by the outer pot 5 and the liner 4 so as to achieve a rapid roasting function; a support 12 is fixedly arranged at the bottom end of the liner 4, a light wave tube 13 is fixedly arranged on the support 12, the light wave tube 13 just faces to the outer pot 5, a screen 14 covers the light wave tube 13, the sheet-shaped heating element 17, the strip-shaped heating element 15 and the light wave tube 13 are respectively electrically connected with a multistage switch and a power supply, and the multistage switch can control on and off of any component in a group consisting of the sheet-shaped heating element 17, the strip-shaped heating elements 15 and the light wave tube 13.

It should be noted that a rack 8 is also arranged in the outer pot 5, the rack 8 and the outer pot 5 are detachably connected such that the outer pot 5 and the rack 8 can be detached and the rack 8 and the outer pot 5 can be singly cleaned, a lifting handle 1 and an upper connector assembly 11 are arranged at the top end of the lid 2, and the upper connector assembly 11 can facilitate power supply of the light wave tube 13 and is convenient to use.

In actual use, the chicken roasting oven capable of conducting multidimensional roasting in embodiment can conduct three-dimensional radiation roasting on a roast chicken by three heating components, namely, the strip-shaped heating elements 15, the sheet-shaped heating element 17 and the light wave tube 13, can have various heating modes by combining the three heating components, and can meet various requirements of roasting the chicken, thawing before roasting, thermally insulating after roasting and the like.

In the description of the present invention, it should be noted that orientations or position relationships indicated by terms “top”, “bottom”, “inner”, “outer”, etc. are orientations or position relationships as shown in the drawings, and these terms are just used to facilitate description of the present invention and simplify the description, but not to indicate or imply that the mentioned apparatus or elements must have a specific orientation and must be established and operated in a specific orientation, and thus, these terms cannot be understood as a limitation to the present disclosure.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

What is claimed is:

1. A chicken roasting oven capable of conducting multidimensional roasting, comprising a housing, a lid, an inner pot and an outer pot, wherein the inner pot is fixedly arranged in the housing, the outer pot is placed in the inner pot, strip-shaped heating elements are arranged on the inner side wall of the inner pot and are connected end to end, a sheet-shaped heating element is arranged at the bottom of the inner pot, the lid can tightly cover the top end of the housing, a thermal insulation plate and a liner are sequentially and fixedly arranged at the bottom end of the lid from top to bottom, a light wave tube is fixedly arranged at the bottom end of the liner, a screen covers the light wave tube, and the sheet-shaped heating element, the strip-shaped heating elements and the light wave tube are respectively electrically connected with a multistage switch and a power supply.

2. The chicken roasting oven capable of conducting multidimensional roasting according to claim 1, wherein the housing comprises an outer housing and a bottom cover, the bottom cover is fixedly connected with the inner pot through screws, and the outer housing is tightly clamped between the bottom cover and the inner pot.

3. The chicken roasting oven capable of conducting multidimensional roasting according to claim 2, wherein at least three feet are fixedly arranged at the bottom end of the bottom cover, and at least two handles are arranged on the outer side wall of the outer housing.

4. The chicken roasting oven capable of conducting multidimensional roasting according to claim 1, wherein a support is fixedly arranged at the bottom end of the liner, the light wave tube is fixedly arranged on the support, and the light wave tube just faces to the outer pot.

5. The chicken roasting oven capable of conducting multidimensional roasting according to claim 1, wherein a rack is arranged in the outer pot, and the rack and the outer pot are detachably connected.

6. The chicken roasting oven capable of conducting multidimensional roasting according to claim 1, wherein the outer pot and the inner pot are detachably connected.

7. The chicken roasting oven capable of conducting multidimensional roasting according to claim 1, wherein a lifting handle is arranged at the top end of the top cover.

8. The chicken roasting oven capable of conducting multidimensional roasting according to claim 1, wherein the lid is further provided with an upper connector assembly.
